(19) United States
(12) Patent Application Publication
(10) Pub. No.: US 2024/0362660 A1
(43) Pub. Date: Oct. 31, 2024

(54) ACCOUNT PROGRAM SYSTEMS AND METHODS

(71) Applicant: Citibank, N.A., New York, NY (US)

(72) Inventors: Sandra REILLY, New York, NY (US); Tim AKPINAR, Brooklyn, NY (US)

(73) Assignee: Citibank, N.A., New York, NY (US)

(21) Appl. No.: 18/771,248

(22) Filed: Jul. 12, 2024

Related U.S. Application Data
(63) Continuation-in-part of application No. 18/241,017, filed on Aug. 31, 2023.
Application No. 18/241,017 is a continuation of application No. 17/229,342, filed on Apr. 13, 2021, now Pat. No. 11,763,329.
(60) Provisional application No. 63/009,626, filed on Apr. 14, 2020.

(51) Int. Cl. G06Q 30/0208; G06N 20/00; G06Q 50/20; G06Q 50/26

(52) U.S. Cl. CPC G06Q 30/0208; G06N 20/00; G06Q 50/2053; G06Q 50/26

(57) ABSTRACT

Presented herein are systems and methods of providing alerts based on events across network environments. A server may receive, from a plurality of computing devices, event data indicating completion of at least one objective of a plurality of objectives by a plurality of users associated with at least one network environment. Each of the plurality of objectives may define a corresponding action to be completed. The server may transfer a plurality of transactions from the first account to a plurality of second accounts associated with the plurality of users based on the event data indicating the completion of the at least one objective. The server may determine that the remaining amount in the first account is less than the threshold determined using a machine learning model. The server may automatically generate an alert message comprising an indicator that the remaining amount in the first account is less than the threshold.

### CROSS-REFERENCE TO RELATED PATENT APPLICATIONS

The present application claims priority under 35 U.S.C. § 120 as a continuation-in-part of U.S. patent application Ser. No. 18/241,017, titled “Account Program Systems and Methods,” filed Aug. 31, 2023, which claims priority under 35 U.S.C. § 120 as a continuation of U.S. patent application Ser. No. 17/229,342, titled “Account Program Systems and Methods,” filed Apr. 13, 2021, now U.S. Pat. No. 11,763,329, which claims priority to U.S. Provisional Application No. 63/009,626, titled “Account Program Systems and Methods,” filed Apr. 14, 2020, each of which are hereby incorporated by reference in their entireties.

### TECHNICAL FIELD

The disclosed technology generally relates to systems and methods of providing alert messages in response to detection of events across different network environments.

### BACKGROUND

A network environment may be defined to include a multitude of user device (e.g., numbering in the tens or hundreds of thousands). It may be difficult to monitor the status of each user device, especially when the user devices may be connected with the network environment in a transient manner, entering and leaving the network over time. In certain applications, the server administrating the network environment may be unable to interface with servers administrating other network environment, exacerbating the difficulties with monitoring. For instance, these network environments may not be relying on the same software platforms and thus unable to communicate with one another.

### SUMMARY

In each network environment, each user may use their user device to carry out or record actions. The actions may be in furtherance of achieving one or more defined objectives. These objectives may be defined by a type of organization associated with the network environment (e.g., using one or more files), and may be configured to induce a particular type of action or behavior on the part of the user via the user device. Upon provision, the user device may monitor for actions associated with the objectives by the user. When an action is carried out or recorded by the user, the user device may generate event data identifying the objective achieved through the action.

There may be, however, a number of challenges in monitoring the event data from the user devices. For one, the user may move from one network environment to another network environment, resulting in the inability to track the event data across different network environments. This problem may be exacerbated when the two network environments are unable to interface with one another. For another, even within a single network environment, the number of users may make it difficult to track, especially when users are not always connected to the network environment. In addition, the objectives may be tied transfer of amounts from a central account to individual accounts associated with the users. The numbers of users may make it difficult to ensure that the transfer of the amount tied to the accomplishment of the objectives is successfully effectuated.

To address these and other technical challenges, a system server may be communicatively coupled with the network environments to monitor statuses and event data associated with the users. The user devices may be communicatively coupled with at least one of the network environments or the system server, or both. The system server may maintain a set of objectives for users to accomplish as defined by a given organization associated with the network environments. The system server may provide an identification of the objectives to each user device upon request from the user. Upon provision, the user device may monitor actions performed or recorded by the user in furtherance of the objectives. When the objective is determined to be accomplished, the user device may generate event data indicating the accomplishment of the objective and send the event data to the system server.

In conjunction, the system server may monitor the user devices for event data indicating the accomplishment. As the event data are received from multiple user devices, the system server may in conjunction use a machine learning (ML) model to determine a threshold against which to compare the amount to be transferred from the system account to the individual user accounts. The ML model may have been trained and established using a historical data indicating rates of completion of the objectives as well as previous transfer associated with the rates. By applying the ML model, the system server may determine the threshold to be transferred for a given time period. With the determination, the system server may compare the amount with the threshold. If the amount is above a threshold, the system server may refrain from providing any alerts. On the other hand, if the amount is below the threshold, the system server may generate and provide an alert to provide the administrator information regarding the system account.

In this manner, the system server may improve and enhance the functionality of the user device, allowing the user device to communicate event data in real-time irrespective of the network environment in which the user device is in. The improved functionality may allow for distribution of computer resource consumption (e.g., processor and memory) over an extended time period on the user device, as the user device is no longer limited to transmitting event data to when the user device is connected with the network environment. The system server may also allow for greater amount of interfacing and communication across network environments that would have otherwise lacked such capabilities to exchange data. Furthermore, by using the ML model, the system server may be able to more objectively set the threshold at which to compare the transfer amounts. The ability to objectively set thresholds may allow for the system server to better limit and control when to provide alerts to the administrator overseeing the objectives, thereby improving the quality of human-computer interactions (HCI) between the user and the administrator device.

In one aspect, a system includes a processor and a non-transitory computer-readable medium comprising instructions that, when executed by the processor, is configured to perform operations including generating a plurality of goals in a municipal database that are available for a plurality of students associated with one of a plurality of schools within a school district. The operation can include, upon receiving data indicating a completion of at least one goal, transferring funds from a municipal account into a plurality of student accounts corresponding to the data indicating the completion of the at least one goal. The operation can include reconciling a plurality of transactions corresponding to the transfer of funds from the municipal account based upon completion of any of the plurality of goals by at least one of the plurality of students in the school district; upon reconciling the transactions, determining that a remaining amount in the municipal account is less than a predetermined threshold. The operation can include automatically generating and transmitting an alert message to a dashboard user interface of the municipal account for display on a municipal workstation comprising an indicator that the remaining amount in the municipal account is less than the predetermined threshold so that the dashboard of the municipal account has immediate access to transaction information and municipal account information.

In another aspect, a system includes a processor and a non-transitory computer-readable medium comprising instructions that, when executed by the processor, is configured to perform operations including reconciling a plurality of transactions transferring funds to a student account from a municipal account upon a corresponding student accomplishing at least one of a plurality of goals, wherein the student is associated with one of a plurality of schools within a school district, and wherein the plurality of goals are each based upon completion of an action stored in a municipal database. The operation can include, upon reconciling the transactions, determining that a remaining amount in the municipal account is less than a predetermined threshold. The operation can include automatically generating and transmitting an alert message to a dashboard user interface of the municipal account for display on a municipal workstation comprising an indicator that the remaining amount in the municipal account is less than the predetermined threshold so that the dashboard of the municipal account has immediate access to transaction information and municipal account information.

In another aspect, a method includes generating a plurality of goals in a municipal database that are available for a plurality of students associated with one of a plurality of schools within a school district. The method can include upon receiving data indicating a completion of at least one goal, transferring funds from a municipal account into a plurality of student accounts corresponding to the data indicating the completion of the at least one goal. The method can include reconciling a plurality of transactions corresponding to the transfer of funds from the municipal account based upon completion of any of the plurality of goals by at least one of the plurality of students in the school district. The method can include upon reconciling the transactions, determining that a remaining amount in the municipal account is less than a predetermined threshold. The method can include automatically generating and transmitting an alert message to a dashboard user interface of the municipal account for display on a municipal workstation comprising an indicator that the remaining amount in the municipal account is less than the predetermined threshold so that the dashboard of the municipal account has immediate access to transaction information and municipal account information.

In yet another aspect, a system may include a server having one or more processors coupled with memory. The server may receive, from a plurality of computing devices, event data indicating completion of at least one objective of a plurality of objectives by a plurality of users associated with at least one network environment. Each of the plurality of objectives may define a corresponding action to be completed. The server may apply a machine learning model to the event data to determine a threshold against which to compare a remaining amount in a first account associated with an administrator device of the at least one network environment. The machine learning model may be trained using historical data indicating a rate of completion of one or more of the plurality of objectives and previous transfers from the account. The server may transfer a plurality of transactions from the first account to a plurality of second accounts associated with the plurality of users based on the event data indicating the completion of the at least one objective. The server may determine, responsive to transfer, that the remaining amount in the first account is less than the threshold determined using the machine learning model. The server may automatically generate an alert message comprising an indicator that the remaining amount in the first account is less than the threshold. The server may transmit the alert message to present via a graphical user interface of the account to provide the administrator device immediate access to information regarding the first account.

In some embodiments, the server may apply a second machine learning model to the data determine a predicted likelihood of at least one user of the plurality of users of completing one or more of the plurality of goals. The second machine learning may be trained using second historical data including an indication of whether one or more of the plurality of goals were completed, In some embodiments, the at least one network environment may include at least one of a school district, an organization chapter, a municipality, a region, or a state, and the server may be configured to be in communication across a plurality of network environments including the at least one network environment. In some embodiments, the plurality of objectives may be associated with at least one of a student incentive program, a baby bond management program, a mutual aid organization program, a club management program, or a capital savings management program.

In some embodiments, the server may provide, to the plurality of computing devices associated with the corresponding plurality of users, access to data identifying the plurality of objectives defined by the administrator device. In some embodiments, the server may transmit a second alert message comprising a second indicator automatically generated in response to determining that the remaining amount in the first account satisfies at least one threshold of a plurality of thresholds defined by the administrator device. In some embodiments, the server may stop, responsive to determining that the remaining amount is less than the threshold, transfer of amounts from the first account associated with the administrator device to one or more of the plurality of second accounts associated with the plurality of users.

In some embodiments, the server may receive, from the plurality of computing device when in communication with the server, the event data indicating completion of the at least one objective selected by a subset of the plurality of users over a plurality of locales. In some embodiments, the server may automatically generate the alert message comprising the indicator that transfer of amounts from the first account associated with the administrator device has been stopped responsive to determining that the remaining amount is less than the threshold. In some embodiments, the server may transmit the alert message to present as a user interface element on the graphical user interface via which to provide the administrator device the immediate access to the information regarding the first account.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1 illustrates a block diagram of components of a system for providing alerts based on events across network environments, according to an embodiment.

FIG. 2 illustrates an example flow diagram of a process executed in the system for monitoring events, according to an embodiment.

FIG. 3 illustrates a dashboard of an administrator device of the system for monitoring events of FIG. 1, according to an embodiment.

FIG. 4A illustrates the dashboard of FIG. 3 including an alert message, according to an embodiment.

FIG. 4B illustrates the dashboard of FIG. 3 including another alert message, according to an embodiment.

FIG. 5 illustrates an example flow diagram of a method of providing alerts based on events across network environments, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

The present disclosure is directed to systems and methods for providing alerts based on events across network environments. A system server may be communicatively coupled with the network environments to monitor statuses and event data associated with the users. The system server may monitor user devices to detect the accomplishment of objectives. When the objective is determined to be accomplished, the user device may generate event data indicating the accomplishment of the objective and send the event data to the system server. The system server in turn may determine the completion of the objective using the event data from the user device. As the event data are received from multiple user devices, the system server may use a machine learning (ML) model to determine a threshold against which to compare the amount to be transferred from the system account to the individual user accounts. The ML model may have been trained and established using a historical data indicating rates of completion of the objectives as well as previous transfer associated with the rates. With the determination, the system server may compare the amount with the threshold. If the amount is above a threshold, the system server may refrain from providing any alerts. On the other hand, if the amount is below the threshold, the system server may generate and provide an alert to provide the administrator information regarding the system account.

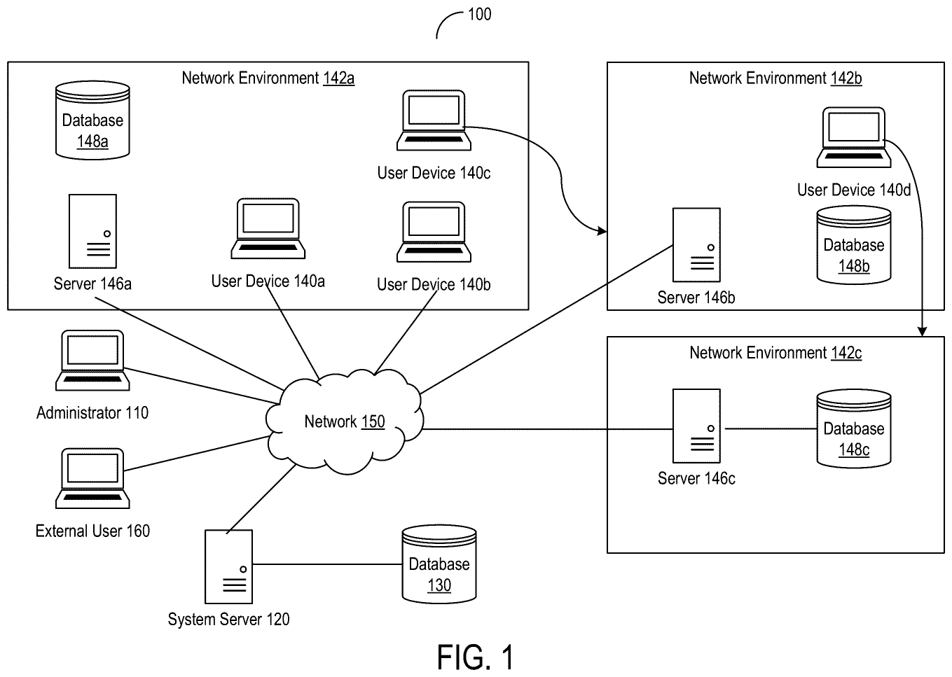

FIG. 1 illustrates a block diagram of components of a system 100 for providing alerts based on events across network environments. The system 100 may include a system server 120, system database 130, end-user devices 140a, 140b, 140c, and 140d (collectively user devices 140), network environments 142a, 142b, and 142c (collectively network environments 142), internal servers 146a, 146b, and 146c (collectively internal servers 146), internal databases 148a, 148b, and 148c (collectively internal databases 148) and an administrator device (or workstation) 110, and an external user device 160. The above-mentioned components may be connected to each other through a network 150. Examples of the network 150 may include, but are not limited to, private or public LAN, WLAN, MAN, WAN, and the Internet. The network 150 may include wired and/or wireless communications according to one or more standards and/or via one or more transport mediums. The system 100 is not confined to the components described herein and may include additional or other components, not shown for brevity, which are to be considered within the scope of the embodiments described herein.

In the present disclosure, the administrator device 110 can display an administrator account, the external user device 160 can display an external account, and the user device 140 can display a user account. However, embodiments are not limited thereto, and the administrator account, parent/guard account, and user account can be displayed on any device with a display and a connection to network and the proper credentials. In the present disclosure, the administrator device 110 can be interchangeable with administrator account, the external user device 160 can be interchangeable with external account, and the user device 140 can be interchangeable with user account. Furthermore, although only one administrator device 110 is shown in FIG. 1, embodiments are not limited thereto.

The administrator device 110 can be a device operated by an administrator of the one or more network environments 142a-c. For example, for a student incentive program, the administrative device 110 may be operated by the school district(s) or by a municipality (e.g., a city) or both. Depending on a program and/or the system 100 implemented by the school district(s) and/or city, the administrator device 110 can be in each of the school district(s) and/or city. For example, the administrator in the city can be a program manager who can generally manage the program and approve and/or deny incentive awards based on a review of the users' activity. In this disclosure, the administrator device 110 can include the administrator in the school district(s) and/or the city.

The communication over the network 150 may be performed in accordance with various communication protocols such as Transmission Control Protocol and Internet Protocol (TCP/IP), User Datagram Protocol (UDP), and IEEE communication protocols. In one example, the network 150 may include wireless communications according to Bluetooth specification sets or another standard or proprietary wireless communication protocol. In another example, the network 150 may also include communications over a cellular network, including, e.g., a GSM (Global System for Mobile Communications), CDMA (Code Division Multiple Access), EDGE (Enhanced Data for Global Evolution) network.

The system server 120 may generate and display an electronic platform configured to use various computer models (including artificial intelligence and/or machine learning models) to display the status of a user incentive program (“program”). The electronic platform may include graphical user interfaces (GUI) displayed on the user devices 140, the external user device 160 and/or the administrator device 110. An example of the electronic platform generated and hosted by the system server 120 may be a web-based application or a website configured to be displayed on different electronic devices, such as mobile devices, tablets, personal computer, and the like. In a non-limiting example, a administrator operating the administrator device 110 may access the platform, input incentive program data or characteristics and other data, and further instruct the system server 120 to transfer funds into or out of an operator account.

The operator account can include the funds that the administrator allocated for the incentive program. In addition, the program can include third party accounts that can also provide incentive amounts to the user account. For example, a parent can have a parent account that has funds that are allocated by the parent(s) who provide incentive awards to the user for meeting certain incentives. Another example, a non-profit organization can create an account that has funds allocated by the organization and used to incentivize users to achieve certain objectives. The term “operator account” contemplates all accounts set up by the administrator accounts.

The system server 120 may utilize the methods and systems described herein to process and/or administer the user incentive program and display the results and/or status on the user devices 140 or adjust the configuration of one of user devices 140. The system server 120 may display the status on the administrator device 110 itself as well.

The system server 120 may host a website accessible to users operating any of the electronic devices described herein (e.g., end users), where the content presented via the various webpages may be controlled based upon each particular user's role or viewing permissions. The server 120 may be any computing device comprising a processor and non-transitory machine-readable storage capable of executing the various tasks and processes described herein. Non-limiting examples of such computing devices may include workstation computers, laptop computers, server computers, and the like. While the system 100 includes a single server 120, the server 120 may include any number of computing devices operating in a distributed computing environment, such as a cloud environment.

The system server 120 may execute software applications configured to display the electronic platform (e.g., host a website), which may generate and serve various webpages to the administrator device 110, external user device 160 and/or user devices 140. Different users may use the website to view and/or interact with the user incentive program.

The system server 120 may be configured to require user authentication based upon a set of user authorization credentials (e.g., username, password, biometrics, cryptographic certificate, and the like). The system server 120 may access the system database 130 configured to store user credentials, which the system server 120 may be configured to reference in order to determine whether a set of entered credentials (purportedly authenticating the user) match an appropriate set of credentials that identify and authenticate the user.

The system server 120 may also store data associated with each user operating one or more administrator devices 110, external user device 160 and/or user devices 140. The server 120 may use the data to weigh interactions while training various AI models accordingly. For instance, the server 120 may indicate that a user is a user whose inputs may be monitored and used to train the machine learning or other computer models described herein.

The system server 120 may generate and host webpages based upon a particular user's role within the system 100. In such implementations, the user's role may be defined by data fields and input fields in user records stored in the system database 130. The system server 120 may authenticate the user and may identify the user's role by executing an access directory protocol (e.g. lightweight directory access protocol). The system server 120 may generate webpage content that is customized according to the user's role defined by the user record in the database 130.

The system server 120 may receive program data (e.g., incentive selection data, incentive completion data, funding data) from a user or retrieve such data from a data repository, analyze the data, and display the results on the electronic platform. For instance, in a non-limiting example, the system server 120 may query and retrieve completed incentives from the database 130 and combine the incentive selections from a user operating the user device 140a. The system server 120 may then use various models (stored within the system database 130) to analyze the retrieved data. The system server 120 then displays the results (e.g., likelihood of user's completion of incentive) via the electronic platform on the administrator device 110, external user device 160 and/or the user device 140a. The database 130 may store data concerning users (e.g., location, affiliated organizations, device type, and other traits), incentive selections, incentive completion rates, received amounts, and others. The collected data can be used to train the machine learning model to predict, for example, the likelihood of a user's completion of an incentive goal, the amount of money the user is expected to earn with the incentives, or a list of objectives that a particular user should seek to accomplish/complete in the next time period, etc.

User devices 140 may be any computing device comprising a processor and a non-transitory machine-readable storage medium capable of performing the various tasks and processes described herein. Non-limiting examples of a user device 140 may be a workstation computer, laptop computer, tablet computer, and server computer. In operation, various users may use user devices 140 to access the GUI operationally managed by the system server 120. Specifically, the user devices 140 may include a parent's computer, a guardian's computer, a sibling or relative's computer, a computer at a program, etc.

The administrator device 110 may represent a computing device operated by a system administrator. The administrator device 110 may be configured to display data retrieved, the status and/or status updates regarding the user incentive program retrieved from the server 120 where the system administrator can monitor various models utilized by the system server 120 and/or user devices 140 and/or facilitate training or calibration of the neural networks that are maintained by the system server 120.

In operation, a user may access an application executing on the user device 140a and select an objective for completion. The server 120 can receive the selection and register the objective on a corresponding user account. When the user accomplishes the goal, the user can input into the user device 140a that the goal has been accomplished. The administrator device 110 can display an alert message, generated and transmitted by the system server 120, indicating that the user accomplished the goal. The system server 120 can keep a record of the user's accomplishments in the database 130 and make various predictions regarding the user's future ability to accomplish goals based on a trained neural network. The system server 120 may be in communication (real-time or near real-time) with the administrator device 110, such that a system server/computer hosting the administrator device 110 can adjust the administrator device 110 based on the status of the program that is updated by the system server 120.

Network environments 142a, 142b, and 142c may each include a defined network for a group of devices (e.g., public school district, municipality, an association, an organization, an enterprise network, among others). The network environment 142a can include the internal server 146a, internal database 148a, user devices 140a, 140b and 140c. The network environment 142b can include user device 140d, the internal server 146b, and internal database 148b. The network environment 142c can include the school district 146c and the internal database 148c. The internal databases 148 can store data regarding the users in the corresponding school districts such as attendance records and grades.

The internal servers 146 can be connected to the internal databases 148 and transmit the data to the system server 120 on a regular basis or on demand. For example, at the end of each time period, the internal servers 146 can transmit the data related to achievement of objectives to the system server 120 via the network 150. The system server 120 can receive the data and automatically determine whether the users in the respective network environments 142 were able to accomplish their goals that relate to the attendance and/or grades. For example, if the user for user device 140a had the goal of having a perfect attendance record, the internal server 146a can retrieve the corresponding attendance record data from the internal database 148a and transmit the data to the system server 120. The system server 120 can automatically determine whether the user was able to accomplish the goal of having a perfect attendance record for the semester based on the goal that was retrieved from the database 130. The system server can transfer the corresponding incentive amount from the operator account to the user account for the user.

In some embodiments, the system 100 may be for a student incentive management system. The system server 120 may reconcile a plurality of transactions transferring funds to a student account from a municipal account upon a corresponding student accomplishing at least one of a plurality of goals to obtain an incentive (e.g., monetary award). The objectives are each based upon completion of an action stored in a municipal database, and an incentive is paid to a student account from a municipal account upon completion of the action. Upon reconciling the transactions, the system server 120 may determine that a remaining amount in the municipal account is less than a predetermined threshold. The system server 120 may automatically generate and transmit an alert message to a dashboard user interface of the municipal account for display on a municipal workstation comprising an indicator. The indicator may identify that the remaining amount in the municipal account is less than the predetermined threshold so that the dashboard of the municipal account has immediate access to transaction information and municipal account information.

One of the many problems facing students today is the ever-increasing costs of higher education. Another problem is a sense of helplessness and/or lack of motivation to succeed. One way to incentivize students to work hard and do well in school is to provide financial incentives. However, not every child is privileged to grow up in a home or even the parents/guardians that can provide this type of motivation. Therefore, a public institution such as a school district or a city can provide the funding to enable this type of motivation. However, managing a program that can track each student's progress and financial awards can be very difficult and resource-intensive, particularly for a school district that has not conventionally provided such functionality. One way to accomplish this is to create a student incentive management system (“system”) that an administrator from the institution can operate. The system can allow the administrator to create incentives that a student can receive upon accomplishing a goal and associate the goal with a financial incentive that the student can receive upon completion of that goal. The received incentive (e.g., monetary award) can be applied towards any type of post-secondary education that the student wants to commit to.

Creating and reliably managing a system that can monitor and facilitate thousands, if not millions, of students' progress and their financial accounts can be extremely challenging and complex. A school district may have many students that they are trying to serve. For example, for the 2020-2021 school year, the Los Angeles Unified School District has about 665,000 students and the New York City Department of Education has about 1.1 million students. And each student who participates in this program can choose to complete any number of goals with varying amounts of incentives tied to them. Because there is potentially an infinite number of goals and an infinite number of incentives, the volume of data and transactions that need to be securely managed can be overwhelming. Furthermore, there can be a large number of transactions that can occur at any given time. For example, one day (or in one hour or four hours), there can be 50 transactions in which 50 goals were accomplished (by 50 or fewer students) and 50 incentives are paid out from an operator account (e.g., account for the school district or city). On another day, there can be 5000 transactions in which 5000 goals were accomplished (by 5000 or fewer students) and 5000 incentives are paid out to the student accounts from the operator account. There is also the risk of potentially running out of money in the program because so many transactions are happening at any given time.

Using the system server 120, administrators reliably manage and facilitate a student incentive program across multiple network environments 142 (e.g., school districts). The system server 120 can reconcile all of the unreconciled transactions from different network environments 142 or student users associated with the user devices 140. When the reconciliation is complete, the system server 120 can determine whether the remaining amount is below a predetermined threshold and alert the administrator. The administrator can then decide whether or not to deposit more funds into the account in order to continue incentivizing the students. While described primarily in terms of the student incentive management system, the system 100 may be used across various programs, but not limited to those examples provided herein.

In some embodiments, the system 100 may be for a baby bond management program. The baby bond management program may be to keep track incentives to induce users (e.g., parents) to save money for children in the form of financial instruments (e.g., cash, bills, notes, or bonds). The objectives for the baby bond management program may include saving money, children health care, and educational milestones, among others, and may be associated with a matching amount by the administrator of the program. In the baby bond management program, the system server 120 may monitor for event data from user devices 140 across different network environments 142 (e.g., school districts, municipalities, counties, regions, or states). The event data may identify whether the parent has completed at least one of the objectives. The system server 120 may determine a threshold to compare the transfer amount using a machine learning (ML) model. The ML model may have been trained using training data identifying historical data indicating rates of completion of the objectives as well as previous transfer associated with the historic completion rates. The system server 120 may provide an alert to the administrator of the baby bond management program if the amount to be transferred is below the determined threshold.

In some embodiments, the system 100 may be for a mutual aid management program. The mutual aid management program may be to keep track of incentives to induce users (e.g., members) to conduct certain actions in furtherance of life goal defined by the organization associated with the program. The objectives for the mutual aid management program may include donations (e.g., in the form of currency or items), attending events hosted by the organization (e.g., soup kitchen volunteering), and performing activities (e.g., exercising, reading, or refraining from alcohol) in service of the organization, among others, and may be associated with a matching amount by the administrator of the program. In the mutual aid management program, the system server 120 may monitor for event data from user devices 140 across different network environments 142 (e.g., organization's chapters, municipalities, counties, regions, or states). The event data may identify whether the member has completed at least one of the objectives. The system server 120 may determine a threshold to compare the transfer amount using a machine learning (ML) model. The ML model may have been trained using training data identifying historical data indicating rates of completion of the objectives as well as previous transfer associated with the historic completion rates. The system server 120 may provide an alert to the administrator of the mutual aid management program if the amount to be transferred is below the determined threshold.

In some embodiments, the system 100 may be for an investment club management program. The investment club management program may be to keep track of incentives to induce users (e.g., members) to conduct certain actions in furtherance of goals (e.g., acquisition of investment asset or property) defined by the organization associated with the program. The objectives for the investment club management program may include saving towards the fund, attending events hosted by the organization, and performing activities in service of the organization, among others, and may be associated with a matching amount by the administrator of the program. In the investment club management program, the system server 120 may monitor for event data from user devices 140 across different network environments 142 (e.g., organization's chapters, municipalities, counties, regions, or states). The event data may identify whether the member has completed at least one of the objectives. The system server 120 may keep track of the amount in the central fund (e.g., for acquisition of investment targets) associated with the club. The system server 120 may determine a threshold to compare the transfer amount using a machine learning (ML) model. The ML model may have been trained using training data identifying historical data indicating rates of completion of the objectives as well as previous transfer associated with the historic completion rates. The system server 120 may provide an alert to the administrator of the investment club management program if the amount to be transferred is below the determined threshold.

In some embodiments, the system 100 may be for a capital savings management program. The capital savings management program may be to keep track of incentives to induce users (e.g., participants) to conduct certain actions in furtherance of goals (e.g., save towards down payment, improvement on property, or public infrastructure) defined by the organization associated with the program. The objectives for the capital savings management program may include saving towards the fund, learning skills for carrying out the improvement, and performing activities in service of the organization, among others, and may be associated with a matching amount by the administrator of the program. In the capital savings management program, the system server 120 may monitor for event data from user devices 140 across different network environments 142 (e.g., neighborhood, homeowner's association, municipalities, counties, regions, or states). The event data may identify whether the member has completed at least one of the objectives. The system server 120 may keep track of the amount in the central fund (e.g., for inducing homeowners to make improvements) associated with the organization. The system server 120 may determine a threshold to compare the transfer amount using a machine learning (ML) model. The ML model may have been trained using training data identifying historical data indicating rates of completion of the objectives as well as previous transfer associated with the historic completion rates. The system server 120 may provide an alert to the administrator of the capital savings management program if the amount to be transferred is below the determined threshold.

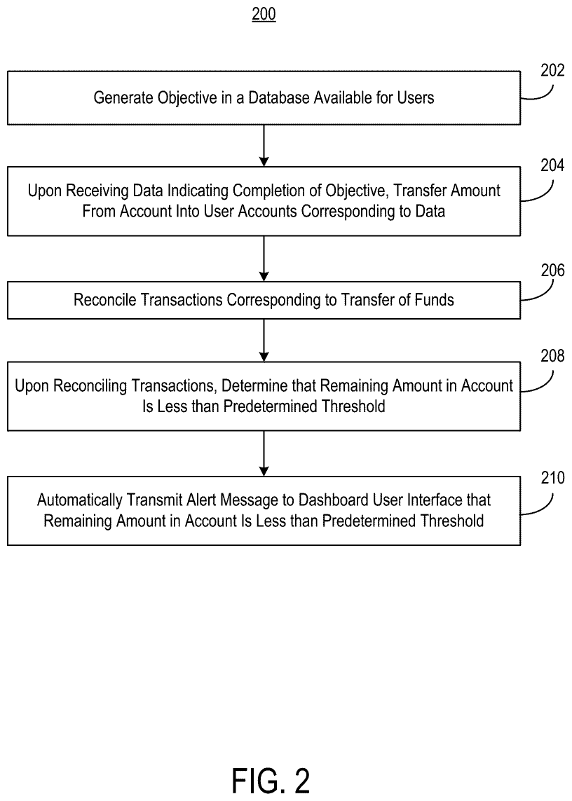

FIG. 2 illustrates a flow diagram of a process executed in a system for monitoring events, according to an embodiment. The method 200 includes operations 202-210. However, other embodiments may include additional or alternative steps, or may omit one or more steps altogether. The method 200 is described as being executed by a data processing system (e.g., a computer similar to the system server 120 described in FIG. 1). However, one or more steps of method 200 may be executed by any number of computing devices operating in the distributed computing system described in FIG. 1. For instance, one or more computing devices may locally perform part or all of the steps described in FIG. 2 or a cloud device may perform such steps.

At operation 202, the system server 120 may generate a plurality of goals that are available for the users. The goals can be geared or directed to helping a user have better behavior or be a better user. For a school incentive, an example of an objective may include having a perfect attendance in school or obtaining straight A's for a semester. The goals may be stored in the database (or municipal database or an internal database) 130. The database 130 may be operated by a municipality, a school district, a state, national/federal entity like the Department of Education (hereinafter referred to as “operator”). For simplicity, the disclosure will describe the example of when the operator is a school district, but embodiments are not limited thereto.

There can be a plurality of incentive types. Although three different types of incentives have been discussed herein, the embodiments are not limited thereto, and fewer or additional types of incentives can be implemented. The first type can be based on a predetermined goal within the system 100 and available for completion by any user within the school district. For example, an administrator can award an incentive to any user who registers their account with the system 100. The system 100 can include a predefined incentive amount that is tied to meeting this predetermined goal such as $10 for registering their contact info with the system. Accordingly, every user can be awarded the incentive award for any of these goals.

A second type of incentive can be based on a goal that the user can define and is not predetermined within the system 100. For example, a user may want to set a goal or incentive for himself or herself by creating a goal that says “join junior varsity tennis team.” When the user inputs this goal, the administrator can review and approve the incentive as well as associate an appropriate dollar amount for accomplishing the goal. Accordingly, if the user makes the junior varsity tennis team, the user can indicate that the user made the team, and the administrator can approve the incentive award.

A third type of incentive can be based on a behavior goal. For example, a user can receive an incentive award for having a perfect attendance over a period of time such as a month, a quarter or a semester. Once the system server 120 receives data that the user accomplished the goal of perfect attendance, the system server 120 can transfer funds from the operator account to the user account.

The system server 120 can receive a first input from a user indicating that the user has selected one or more goals. Each user may select one or more goals that they want to achieve within a certain time period. For example, a first user may select that the first user wants to receive all A's or B's only miss up to three days of school during the semester. As another example, a second user may select that the second user wants to submit every homework assignment on time and receive an award for a science competition. The goal's timeline can be as long or as short as the operator allows. For example, a goal for one week can be to submit every homework assignment and not be tardy for class. Each goal may have an incentive (or incentive amount) that is associated with the goal that the operator is committing to award the user for accomplishing that goal. For example, for a goal of all A's or B's for the semester, the operator may commit $10 for every user that accomplishes this goal. As another example, for the goal of attaining a perfect attendance for the entire school year, the operator may commit $25 for every user that accomplishes this goal. Accordingly, there can be a large variety and combination of goals and incentives that users may choose from. The database 130 can keep a record of each user, starting with kindergarten until the end of 12^{th} grade, or whenever the user leaves the school district. The database 130 can also keep track of all of the goals that each user selected and whether or not that goal was accomplished. Once the user graduates from 12^{th} grade, the user can withdraw the accumulated funds from the user account and apply it towards post-secondary education costs.

At operation 204, upon the system server 120 receiving data that indicates completion of at least one goal, the system server 120 (or a program manager) can transfer funds from the operator account to the user accounts that corresponds to the incentive amount associated with the accomplished goal. The system server 120 can receive the data in several ways. For example, the user can input in the user device that the user accomplished the goal. Also, the internal server can automatically retrieve the data and transmit it to the system server 120. Also, the administrator and/or external can input data into their respective administrator device 110 or the external user device 160 that the user accomplished their goal.

The system server 120 can transfer funds from the operator account to the user accounts corresponding to the user who accomplished the goal the incentive amount that was associated with the accomplished goal. For example, if the operator had committed $25 for achieving the goal of getting straight A's, and the student user accomplished that goal, the system server 120 can automatically transfer $25 from the operator account to the user account. Alternatively, the system server 120 can transfer the funds from an external account (e.g., parent/guardian) to the user account if the external user had set up a goal in such a manner. For example, when a default incentive amount in the database 130 for a goal of perfect attendance may be $25, the parent/guardian may choose to add an additional $25 to motivate/incentivize the user more. In such a case, the user account would be transferred $25 from the parent/guardian account in addition to the $25 from the operator account. Each transfer of money from the operator account and/or the parent/guardian account to the user account can be referred to as a transaction.

For a large school district or municipality, the number of transfers between the operator account to the user accounts can vary day to day. On one day, the number of transfers may be low with the total amount transferred out of the operator account being low. On another day, the number of transfers may be high with the total amount transferred out of the operator account being high.

At operation 206, the system server 120 can reconcile all of the transactions. Reconciling can include ensuring that all of the incentives that were supposed to be transferred to the user accounts were properly transferred and the amounts debited from the operator accounts equal the amounts credited to the user accounts. The reconciling can occur on a regular basis to ensure that the operator account has a sufficient amount of funds to pay out all of the remaining incentives. For example, the reconciliation can occur every day, every hour, etc. The reconciliation can also occur every predetermined number of transactions. For example, the system server 120 can reconcile the transactions every 1000 transactions, 5000 transactions, etc. The reconciliation can also occur every time a transaction involves more than a certain amount of money. For example, if a user accomplishes a goal that has an associated incentive amount of $100 or more, the system server 120 can reconcile the transactions. When the reconciliation is complete, the administrator can view a remaining amount that is left in the operator account.

The reconciling can also include reconciling user transfers. For example, users can change network environments 142 during a given time period for the objective. For example, referring to FIG. 1, the user for user device 140c can move from the city where network environment 142a is located to a different city where the network environment 142b is located. Then the system 100 has to track the user's data in both network environments 142a and 142b. For example, for a school incentive program, while the user is attending a school in network environment 142a, the internal server 146a and the database 148a can keep an attendance record of the user for that time period. Then when the user moves from the network environment 142a to the network environment 142b, the internal server 146b and the internal database 148b can maintain the user's attendance record starting when the user is part of the network environment 142b.

At the end of the time period, the system server 120 can retrieve the attendance record for the user from both network environment 142a and network environment 142b and reconcile any gaps in attendance. For example, if the user missed the second half of the quarter in network environment 142a, the attendance record from network environment 142a will show that the user was absent for the second half of the quarter. And if the user was not yet in the network environment 142b, the attendance record from network environment 142b will show that the user was absent the first half of network environment 142b. The system server 120 can reconcile the gaps in the user's attendance record and determine that the user still had a perfect attendance record and determine that the user satisfied the perfect attendance goal.

Furthermore, depending on the administrator and network environment, the user may not be able to transfer with the incentive. For example, the network environment 142a or organization that includes the network environment 142a may have a rule where a user is to be in the network environment 142a or a network environment within the organization by the time of graduation of high school in order to receive the full incentive amounts. The rule may indicate that when the user leaves the network environment 142a, the user can only take none or only a portion of the incentive awards with them to the new network environment. The system server 120 can reconcile automatic withdrawals from the user accounts upon a user transfer.

At operation 208, upon the completion of a reconciliation, the system server 120 can determine whether the remaining amount in the operator account is less than a predetermined threshold (or alert threshold). For example, if the remaining amount is $100,000, and the predetermined threshold is $200,000, the system server 120 can determine that the remaining amount is less than the predetermined threshold. As another example, the predetermined threshold can be a percentage of the initial amount. For example, if the initial amount that the operator account included was $10 million, the predetermined threshold can be a percentage (e.g., 10%) of the initial value (10% of $10 million=$1 million). In this case, when the remaining amount is less than $1 million, the system server 120 can determine that the remaining amount is less than the predetermined threshold.

An administrator can modify the predetermined threshold to be greater or less than the default value and/or the previously modified value. For example, if the default predetermined threshold value is $100,000, the administrator can input into the administrator device 110 to change the predetermined threshold to be greater such as $200,000 or less such as $50,000. When the predetermined threshold is a percentage (e.g., 10%), the administrator can increase or decrease the percentage (e.g., 20% or 5%).

In some embodiments, the administrator can set a plurality of predetermined thresholds that are greater than the first predetermined threshold. For example, if the original predetermined threshold is $100,000, the administrator can set two more predetermined thresholds at $200,000 and $350,000. Setting multiple predetermined thresholds can help alert the administrator that the remaining amount is approaching a minimum amount. Then the administrator can decide whether or not to deposit more funds into the operator account.

At operation 210, upon determining that the remaining amount is less than the predetermined threshold, the system server 120 can automatically generate and transmit an alert message to a display of the administrator device 110 that the remaining amount is less than the predetermined threshold. The alert message can appear on a dashboard user interface of the display so that the administrator can immediately access transaction information and operator account information such as the remaining amount, the transactions that were made since the last reconciliation, how many and which users transferred out of the network environment or transferred into the network environment, the number of goals that were achieved, the incentive amounts awarded for each of the goals, etc. For example, upon receiving the alert message through the dashboard, the administrator can have access to all of the data that the system server 120 has access to in the database 130. Although described as an alert message on a dashboard (e.g., a web page user interface on a browser), the alert message can also notify the user as a pop-up message, push notification, text message, graphical indicator, or other electronic notification.

In some embodiments, when the administrator sets multiple predetermined thresholds, the administrator can receive an alert message for every instance that the remaining amount is less than each of the predetermined thresholds. For example, if the predetermined thresholds are set at $100,000, $200,000 and $350,000. The system server 120 can automatically generate and transmit to the administrator device 110 a first alert message when the remaining amount is less than $350,000, a second alert message when the remaining amount is less than $200,000, and a third alert message when the remaining amount is less than $100,000.

In some embodiments, the administrator can set a stop threshold in the operator account. When the system server 120 determines that the remaining amount is less than the stop threshold, the system server 120 can automatically stop or prevent any additional funds from being transferred from the operator account to the user accounts. For example, when the stop threshold is 2% and the initial amount is $10 million, a stop threshold amount is $200,000. In this example, if the remaining amount drops below 2%, the system server 120 can stop or prevent any further transfers between the operator account and the user accounts. When the system server 120 determines that the remaining amount is less than the stop threshold, the system server 120 can automatically generate and transmit an alert message to the administrator device 110 that the system server 120 has stopped transferring funds from the operator account into the user accounts. Then the administrator can choose to deposit more funds into the operator account in order to bring the remaining amount above the stop threshold and/or alert threshold amounts.

In some embodiments, the system server 120 can automatically determine the appropriate stop threshold and/or predetermined threshold by using machine learning. For example, the system server 120 can retrieve from the database 130 various historical data such as users' goal completion rates (e.g., the rate at which the users completed their goals per user and/or per year), incentive amounts awarded (e.g., the incentive amounts that were awarded to each user per goal), numbers of users in the network environment, etc.

The system server 120 can then train a machine learning model to predict how much money that the operating account can expect to transfer to user accounts on any given day. Then based on that prediction, the system server 120 can determine the stop threshold to be high enough that the remaining amount does not go below $0 after any reconciliation and low enough that the operator account can continue awarding incentives to users who accomplish their goals. And the system server 120 can determine an alert threshold based on the stop threshold. For example, the system server 120 can set the alert threshold to be a certain multiple more than the stop threshold (e.g., alert threshold=stop threshold×2) or a certain dollar mount (e.g., alert threshold=stop threshold+$100,000). Accordingly, the administrator can monitor and administer the program without unnecessary interruptions that may happen if the stop threshold is too high (i.e., unnecessarily stopping incentives from being transferred to the user accounts).

In some embodiments, when the remaining amount is below the stop threshold, the system server 120 can deposit a predetermined amount into the operating account. For example, if the system server 120 determines that the remaining amount of $150,000 is below the stop threshold of $200,000, the system server 120 can automatically deposit $100,000 to the operator account so that the remaining amount increases to $250,000. Then the program can continue operating normally and the users can continue to receive incentives for their accomplished goals without interruption.

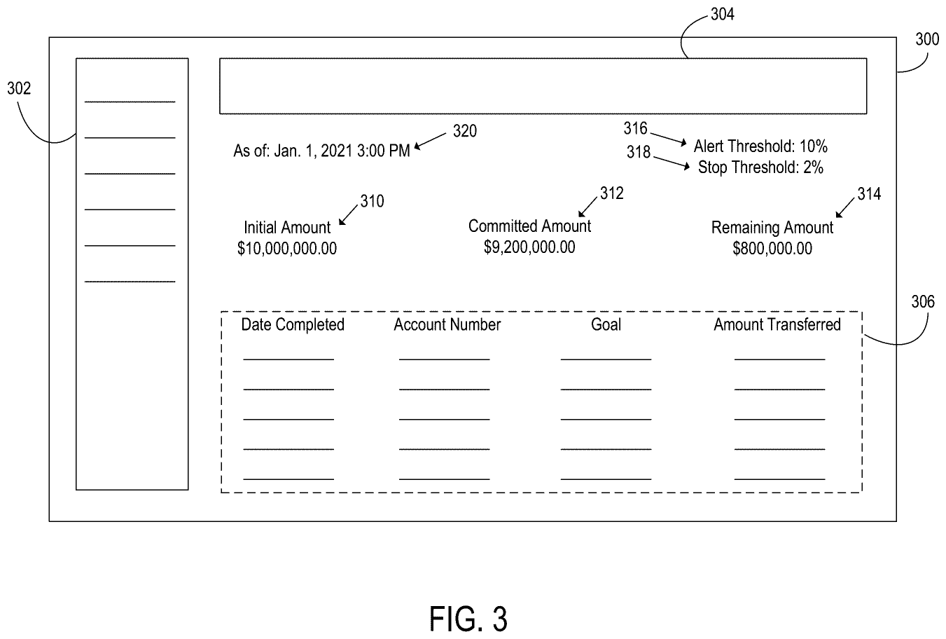

FIG. 3 illustrates a dashboard 300 of an administrator workstation of the system of FIG. 1, according to an embodiment. The dashboard 300 can be displayed using a graphical user interface (GUI) on the display of the administrator device 110 (e.g., as a web page on a browser). The dashboard 300 can display a navigation bar 302, an alert bar 304, and a transaction history section 306. The dashboard can also display the initial amount 310, committed amount 312, remaining amount 314, alert threshold 316, stop threshold 318, and the last reconciled time 320. Although certain words and numbers are shown in FIG. 3, this is for illustrative purposes only, and embodiments are not limited thereto. Further, the sizes and shapes of the have been drawn illustrative purposes only, and embodiments are not limited thereto.

The navigation bar 302 can include different icons and/or text that the user can select to navigate to a different view of the dashboard. For example, FIG. 3 shows a view of the dashboard that includes the transaction history 306 and the initial amount 310, committed amount 312, remaining amount 314, alert threshold 316, stop threshold 318, and the last reconciled time 320. As another example, when the administrator selects another item in the navigation bar 302, the view of the dashboard 300 can change to a list of users who are participating in the program. Another view of the dash 300 can include a list of authorized users and their levels of access/permissions to a particular user account.

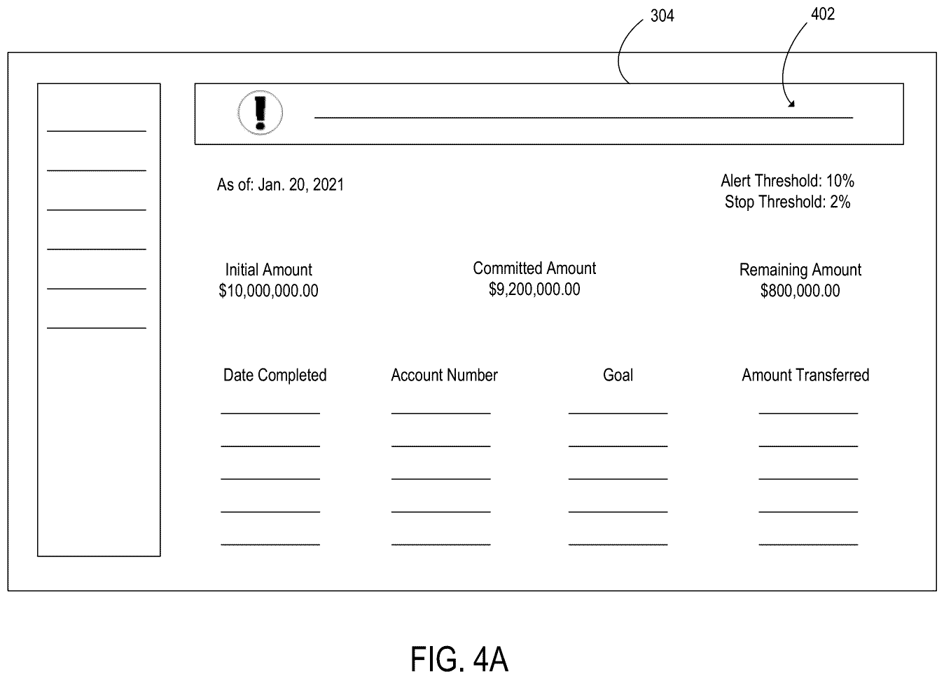

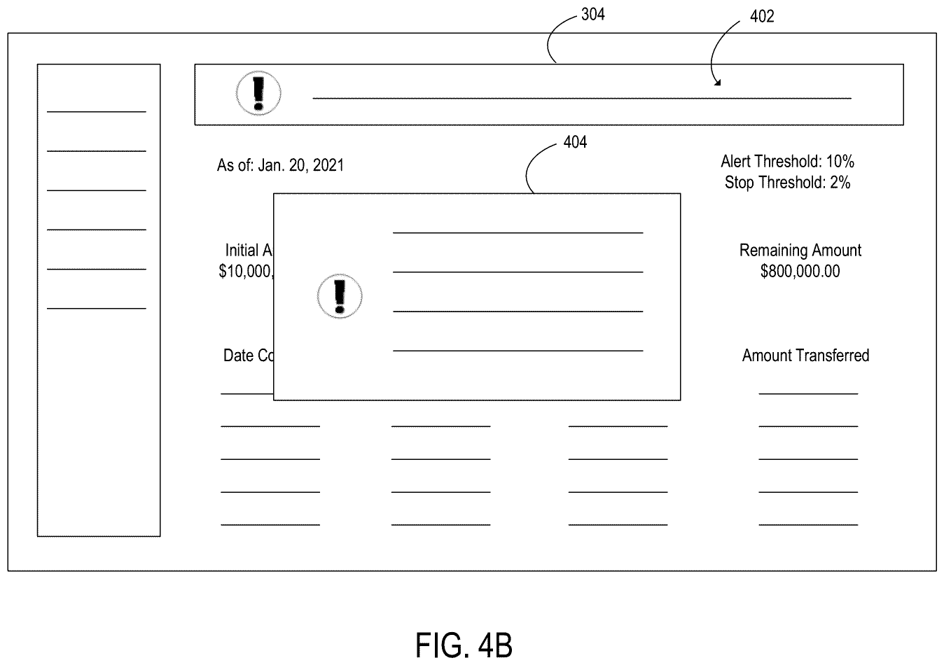

The alert bar 304 can display any alert messages that the system server 120 generates and transmits to the administrator device 110. The alert message can be displayed with a variety of symbols, words and/or numbers, and color schemes to draw the viewer's (e.g., administrator's) attention towards it. Further details on the alert bar 304 is described with regard to FIGS. 4A and 4B.

The transaction history section 306 can display the various transactions that have been completed between the operator account and the user accounts. For example, when funds are transferred from the operator account to a user account, the transaction can be recorded in the transaction history section 306.

The initial amount 310 can include an amount that the administrator deposited into the operator account. The committed amount 312 can include an amount that the operator has already transferred to the user accounts. The remaining amount 314 can include the amount that remains after the transactions have all been completed to date. When the reconciliation is completed, the system server 120 can adjust the committed amount 312 and the remaining amount 314 to reflect the reconciled amounts. The alert threshold 316 can include the predetermined threshold that the administrator has set (or by default) to be the threshold that the remaining amount has to be less than the initial amount in order to be alerted. The stop threshold 318 can include the threshold that when the remaining amount is below the stop threshold, the operator account stops transferring money to the user accounts. The last reconciled time 320 can include the date and/or time that the system server 120 last reconciled all of the transactions in the system/program.

FIG. 4A illustrates the dashboard 300 including an alert message 402, according to an embodiment. For example, when a user opts out of the program, the administrator device 110 can receive and display the alert message 402 in the alert bar 304 that indicates that the user has opted out of the program. As another example, when the system server 120 determines that the remaining amount in the operator account is less than a predetermined threshold, the alert bar 304 can display an alert message 402 indicating that the remaining amount is less than the predetermined threshold. In some embodiments, the alert message 402 can indicate that the remaining amount in the operator account is less than the predetermined threshold which is a dollar amount. In some embodiments, the alert message 402 can include the predetermined amount including a percentage.

FIG. 4B illustrates the dashboard 300 including a pop-up alert 404, according to an embodiment. When the system server 120 determines that the remaining amount is less than the predetermined threshold, the system server 120 can automatically generate and transmit an alert message to the administrator device 110. The administrator device 110 can then display a pop-up alert 404 that includes the alert message. The pop-up alert 404 can be displayed in addition to the alert message in the alert bar 304 to ensure that the administrator is alerted to the remaining amount in the operator account.

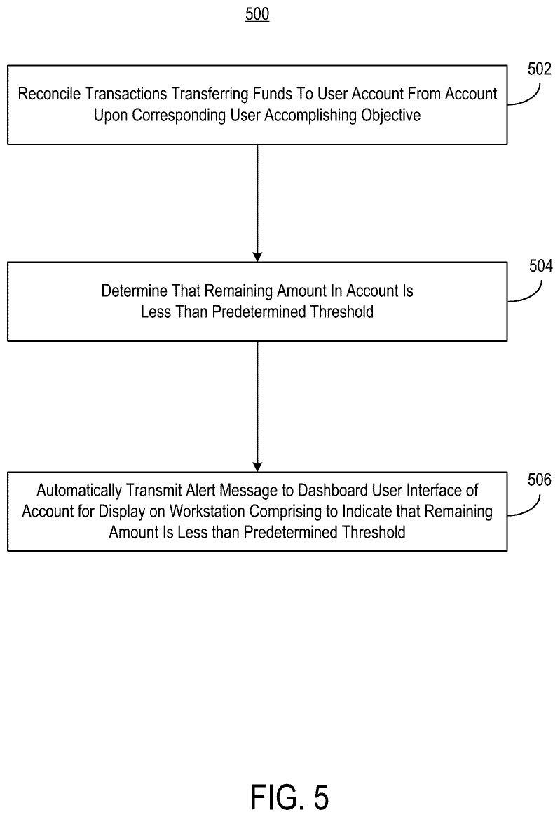

FIG. 5 illustrates a flow diagram of a method 500 of providing alerts based on events across network environments. The method 500 includes operations 502-506. However, other embodiments may include additional or alternative steps, or may omit one or more steps altogether. The method 500 is described as being executed by a data processing system (e.g., a computer similar to the system server 120 described in FIG. 1). However, one or more steps of method 500 may be executed by any number of computing devices operating in the distributed computing system described in FIG. 1. For instance, one or more computing devices may locally perform part or all of the steps described in FIG. 5 or a cloud device may perform such steps.

At operation 502, the system server 120 may reconcile a plurality of transactions transferring funds to a user account from a municipal account upon a corresponding user accomplishing at least one of a plurality of goals. At operation 504, the system server 120 may determine that a remaining amount in the municipal account is less than a predetermined threshold. At operation 506, the system server 120 may automatically generate and transmit an alert message to a dashboard user interface of the municipal account for display on a municipal workstation comprising an indicator that the remaining amount is less than the predetermined threshold.

In this manner, the system server 120 may improve and enhance the functionality of the user device, allowing the user device 140 to communicate event data in real-time irrespective of the network environment 142 in which the user device 140 is in. The improved functionality may allow for distribution of computer resource consumption (e.g., processor and memory) over an extended time period on the user device 140, as the user device is no longer limited to transmitting event data to when the user device 140 is connected with the network environment 142. The system server 120 may also allow for greater amount of interfacing and communication across network environments that would have otherwise lacked such capabilities to exchange data. Furthermore, by using the ML model, the system server 120 may be able to more objectively set the threshold at which to compare the transfer amounts. The ability to objectively set thresholds may allow for the system server 120 to better limit and control when to provide alerts to the administrator overseeing the objectives, thereby improving the quality of human-computer interactions (HCI) between the administrator and the administrator device 110.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method, comprising:
receiving, by a server, from a plurality of computing devices, event data indicating completion of at least one objective of a plurality of objectives by a plurality of users associated with at least one network environment, each of the plurality of objectives defining a corresponding action to be completed;
applying, by the server, a machine learning model to the event data to determine a threshold against which to compare a remaining amount in a first account associated with an administrator device of the at least one network environment, wherein the machine learning model is trained using historical data indicating a rate of completion of one or more of the plurality of objectives and previous transfers from the account;
verifying, by the server, a plurality of transactions transferred from the first account to a plurality of second accounts associated with the plurality of users based on the event data indicating the completion of the at least one objective;
determining, by the server responsive to verifying the plurality of transactions, that the remaining amount in the first account is less than the threshold determined using the machine learning model;
automatically generating, by the server, an alert message comprising an indicator that the remaining amount in the first account is less than the threshold; and
transmitting, by the server, the alert message to present via a graphical user interface of the account to provide the administrator device immediate access to information regarding the first account.

2. The method of claim 1, further comprising applying, by the server, a second machine learning model to the data determine a predicted likelihood of at least one user of the plurality of users of completing one or more of the plurality of goals, wherein the second machine learning is trained using second historical data including an indication of whether one or more of the plurality of goals were completed.

3. The method of claim 1, wherein the at least one network environment comprises at least one of a school district, an organization chapter, a municipality, a region, or a state, and wherein the server is configured to be in communication across a plurality of network environments including the at least one network environment.

4. The method of claim 1, wherein the plurality of objectives is associated with at least one of a student incentive program, a baby bond management program, a mutual aid organization program, a club management program, or a capital savings management program.

5. The method of claim 1, further comprising providing, by the server to the plurality of computing devices associated with the corresponding plurality of users, access to data identifying the plurality of objectives defined by the administrator device.

6. The method of claim 1, further comprising transmitting, by the server, a second alert message comprising a second indicator automatically generated in response to determining that the remaining amount in the first account satisfies at least one threshold of a plurality of thresholds defined by the administrator device.

7. The method of claim 1, further comprising automatically stopping, by the server, responsive to determining that the remaining amount is less than the threshold, transfer of amounts from the first account associated with the administrator device to one or more of the plurality of second accounts associated with the plurality of users.

8. The method of claim 1, wherein receiving the event data further comprises receiving, from the plurality of computing device when in communication with the server, the event data indicating completion of the at least one objective selected by a subset of the plurality of users over a plurality of locales.

9. The method of claim 1, wherein automatically generating the alert message further comprises generating the alert message comprising the indicator that transfer of amounts from the first account associated with the administrator device has been stopped responsive to determining that the remaining amount is less than the threshold.

10. The method of claim 1, wherein transmitting the alert message further comprises transmitting the alert message to present as a user interface element on the graphical user interface via which to provide the administrator device the immediate access to the information regarding the first account.

11. A system, comprising:
a server having one or more processors coupled with memory, the server configured to:
receive, from a plurality of computing devices, event data indicating completion of at least one objective of a plurality of objectives by a plurality of users associated with at least one network environment, each of the plurality of objectives defining a corresponding action to be completed;
apply a machine learning model to the event data to determine a threshold against which to compare a remaining amount in a first account associated with an administrator device of the at least one network environment, wherein the machine learning model is trained using historical data indicating a rate of completion of one or more of the plurality of objectives and previous transfers from the account;
transfer a plurality of transactions from the first account to a plurality of second accounts associated with the plurality of users based on the event data indicating the completion of the at least one objective;
determine, responsive to transfer, that the remaining amount in the first account is less than the threshold determined using the machine learning model;
automatically generate an alert message comprising an indicator that the remaining amount in the first account is less than the threshold; and
transmit the alert message to present via a graphical user interface of the account to provide the administrator device immediate access to information regarding the first account.

12. The system of claim 11, wherein the server is further configured to apply a second machine learning model to the data determine a predicted likelihood of at least one user of the plurality of users of completing one or more of the plurality of goals, wherein the second machine learning is trained using second historical data including an indication of whether one or more of the plurality of goals were completed.

13. The system of claim 11, wherein the at least one network environment comprises at least one of a school district, an organization chapter, a municipality, a region, or a state, and wherein the server is configured to be in communication across a plurality of network environments including the at least one network environment.

14. The system of claim 11, wherein the plurality of objectives is associated with at least one of a student incentive program, a baby bond management program, a mutual aid organization program, a club management program, or a capital savings management program.

15. The system of claim 11, wherein the server is further configured to provide, to the plurality of computing devices associated with the corresponding plurality of users, access to data identifying the plurality of objectives defined by the administrator device.

16. The system of claim 11, wherein the server is further configured to transmit a second alert message comprising a second indicator automatically generated in response to determining that the remaining amount in the first account satisfies at least one threshold of a plurality of thresholds defined by the administrator device.

17. The system of claim 11, wherein the server is further configured to stop, responsive to determining that the remaining amount is less than the threshold, transfer of amounts from the first account associated with the administrator device to one or more of the plurality of second accounts associated with the plurality of users.

18. The system of claim 11, wherein the server is further configured to receive, from the plurality of computing device when in communication with the server, the event data indicating completion of the at least one objective selected by a subset of the plurality of users over a plurality of locales.

19. The system of claim 11, wherein the server is further configured to automatically generate the alert message comprising the indicator that transfer of amounts from the first account associated with the administrator device has been stopped responsive to determining that the remaining amount is less than the threshold.

20. The system of claim 11, wherein the server is further configured to transmit the alert message to present as a user interface element on the graphical user interface via which to provide the administrator device the immediate access to the information regarding the first account.
